(19) United States
(12) Patent Application Publication
(10) Pub. No.: US 2018/0280743 A1
(43) Pub. Date: Oct. 4, 2018

(54) System and Method for Providing a Fire Department Connection (FDC)

(71) Applicant: Karl Walker, South Jordan, UT (US)

(72) Inventor: Karl Walker, South Jordan, UT (US)

(21) Appl. No.: 15/634,831

(22) Filed: Jun. 27, 2017

Related U.S. Application Data
(60) Provisional application No. 62/477,570, filed on Mar. 28, 2017.

(51) Int. Cl. A62C 35/68; A62C 33/00; F16L 37/18; F16L 23/036

(52) U.S. Cl. CPC A62C 35/68; F16L 23/036; F16L 37/18; A62C 33/00

(57) ABSTRACT

A system and method for providing a fire department connection (FDC) to a building fire sprinkler and/or standpipe system comprising carrying and transporting the FDC on a pumper truck with the fire department. The FDC is removed from the pumper truck and coupled to the inlet of the building with a quick-connect. The quick connect is capable of releasably coupling the FDC to the building inlet of a building fire sprinkler and/or standpipe system. When finished, the FDC is removed from the inlet of the building and replaced on the pumper truck. Thus, the FDC remains in the custody of the fire department

### PRIORITY CLAIM

Priority is claimed to U.S. Provisional Patent Application Ser. No. 62/477,570, filed Mar. 28, 2017, which is hereby incorporated herein be reference.

### BACKGROUND

### Field of the Invention

The present invention relates generally to fire department connections (FDCs) or Siamese connections.

### Related Art

A fire department connection (FDC) or Siamese connection is a water connection to a building's fire sprinkler and/or standpipe system that allows the fire department to supplement the fire protection system in case of a fire. Although the building's fire sprinkler and/or standpipe system is connected to a water supply line, the FDC allows the fire department to connect hose lines from a pumper truck to the building's system to provide a supplemental water source. FDCs, however, have a high brass content that makes them targets of theft. The FDC can be twisted off, or even cut off. In addition, FDCs can be the subject of debris and damage. It will be appreciated that if an FDC is clogged, broken or missing, the fire department may not be able to adequately protect the building and/or its occupants during a fire.

### SUMMARY OF THE INVENTION

It has been recognized that it would be advantageous to develop a system and method to resist theft, damage and tampering of an FDC. In addition, it has been recognized that it would be advantageous to develop and system and method to accommodate the different standard sizes (e.g. 6″, 4″, 2½″ or 1½″) of fire sprinkler and/or standpipe systems.

The invention provides an FDC comprising a housing with at least one inlet having a hose fitting capable of being removably coupled to a fire hose, and an outlet; and a quick-connect disposed on the outlet of the housing and capable of releasably coupling the housing and the outlet to a building inlet of a building fire sprinkler and/or standpipe system.

In accordance with a more detailed aspect of the present invention, the FDC can comprise one or more adaptors capable of converting a 6-inch building inlet to a 4-inch quick-connect, and/or a 1½-inch building inlet to a 2½-inch quick-connect.

In addition, the invention provides a method for providing an FDC to a building fire sprinkler and/or standpipe system comprising carrying the FDC on a pumper truck with the fire department. The FDC is transported on the pumper truck to the building with an inlet to the fire sprinkler and/or standpipe system. The FDC is removed from the pumper truck and coupled to the inlet of the building with a quick-connect. A hose is coupled between the pumper truck and the at least one inlet of the FDC, and water is pumped from the truck, through the hose and the FDC, to the fire sprinkler and/or standpipe system of the building. Then, the FDC is removed from the inlet of the building and replaced on the pumper truck. Thus, the FDC remains in the custody of the fire department.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a top view of a fire department connection (FDC) in accordance with an embodiment of the invention.

FIG. 2a is a side view of the FDC of FIG. 1.

FIG. 2b is a cross-sectional side view of the FDC of FIG. 1, taken along line 2b in FIG. 1.

FIG. 3a is a partially cross-sectional top view of the FDC of FIG. 1, shown removed from a building inlet, and shown with a quick-connect in an open configuration.

FIG. 3b is a partially cross-sectional top view of the FDC of FIG. 1, shown coupled to the building inlet, and shown with the quick-connect in a closed/secured configuration.

FIG. 4 is a top view of an adaptor fitting in accordance with an embodiment of the invention and for use with the FDC of FIG. 1, and defining an enlarging adaptor or enlarger.

FIG. 5 is a side view of the adaptor fitting of FIG. 4.

FIG. 6a is an exploded top view of an FDC system in accordance with an embodiment of the invention, shown with the FDC of FIG. 1 and the adaptor fitting of FIG. 4 removed from the building inlet and shown with the quick-connections in the open configuration.

FIG. 6b is a partial cross-sectional top view of the FDC system of FIG. 6a, shown with the FDC of FIG. 1 and the adaptor fitting of FIG. 4 coupled to the building inlet and shown with the quick-connections in the closed/secured configuration.

FIG. 7 is an exploded top view of an FDC system in accordance with an embodiment of the invention, shown with the FDC (e.g. 4″ quick-connect outlet and a pair of 2″ hose inlets) of FIG. 1 and the adaptor fitting (e.g. 4″ quick-connect inlet and 6″ quick-connect outlet) of FIG. 4, and shown with another smaller adaptor fitting (e.g. 2½″ quick-connect inlet and 1½″ quick-connect outlet), defining a reducing adaptor or reducer, and another smaller FDC (e.g. 2½″ quick-connect outlet and single 2″ hose inlet).

FIG. 8a is an exploded partial cross-sectional side view of another FDC in accordance with another embodiment of the invention, shown removed from the building inlet, and shown with a quick-connect in an open configuration.

FIG. 8b is a partial cross-sectional side view of the FDC of FIG. 8a, shown coupled to the building inlet, and shown with the quick-connect in a closed/secured configuration.

FIG. 9a is a schematic cross-sectional end view of another FDC in accordance with another embodiment of the invention, shown with a quick-connect in an open configuration.

FIG. 9b is a schematic cross-sectional side view of the FDC of FIG. 9a, shown with the quick-connect in a closed/secured configuration.

FIG. 10a is a partial schematic cross-sectional end view of another FDC in accordance with another embodiment of the invention, shown with a quick-connect in an open configuration.

FIG. 10b is a partial schematic cross-sectional side view of the FDC of FIG. 10a, shown with the quick-connect in a closed/secured configuration.

FIG. 11a is an exploded partial cross-sectional side view of another FDC in accordance with another embodiment of the invention, shown removed from the building inlet, and shown with a quick-connect in an open configuration.

FIG. 11b is a partial cross-sectional side view of the FDC of FIG. 11a, shown coupled to the building inlet, and shown with the quick-connect in a closed/secured configuration.

FIG. 12a is a top view of another FDC in accordance with another embodiment of the invention, shown removed from the building inlet, and shown with a quick-connect in an open configuration.

FIG. 12b is a top view of the FDC of FIG. 12a, shown coupled to the building inlet, and shown with the quick-connect in a closed/secured configuration.

FIG. 12c is a side view of the FDC of FIG. 12a, shown removed from the building inlet, and shown with the quick-connect in the open configuration.

FIG. 12d is a partial cross-sectional side view of the FDC of FIG. 12a, shown coupled to the building inlet, and shown with the quick-connect in the closed/secured configuration.

FIG. 12e is a cross-sectional side view of the FDC of FIG. 12a, taken along line 12e of FIG. 12a.

FIG. 13a is a top view of another FDC in accordance with another embodiment of the invention, shown removed from the building inlet, and shown with a quick-connect in an open configuration.

FIG. 13b is a partial cross-sectional top view of the FDC of FIG. 13a, shown coupled to the building inlet, and shown with the quick-connect in a closed/secured configuration.

FIG. 13c is a side view of the FDC of FIG. 13a, shown removed from the building inlet, and shown with the quick-connect in the open configuration.

FIG. 13d is a partial cross-sectional side view of the FDC of FIG. 13a, shown coupled to the building inlet, and shown with the quick-connect in the closed/secured configuration.

FIG. 14a is a side view of another FDC in accordance with another embodiment of the invention, shown removed from the building inlet, and shown with a quick-connect in an open configuration.

FIG. 14b is a partial cross-sectional side view of the FDC of FIG. 14a, shown coupled to the building inlet, and shown with the quick-connect in a closed/secured configuration.

FIG. 14c is a top view of the FDC of FIG. 14a, shown removed from the building inlet, and shown with the quick-connect in the open configuration.

FIG. 14d is a top view of the FDC of FIG. 14a, shown coupled to the building inlet, and shown with the quick-connect in the closed/secured configuration.

FIG. 15a is a side view of another FDC in accordance with another embodiment of the invention, shown removed from the building inlet, and shown with a quick-connect in an open configuration.

FIG. 15b is a partial cross-sectional side view of the FDC of FIG. 15a, shown coupled to the building inlet, and shown with the quick-connect in a closed/secured configuration.

FIG. 16a is a schematic cross-sectional side view of an FDC represented by the FDC of FIG. 1 coupled to a building inlet of a fire sprinkler system, and shown with a fire hose of a fire truck coupled to the FDC.

FIG. 16b is a schematic cross-sectional top view of an FDC represented by the FDC of FIG. 1 coupled to a building inlet of a fire sprinkler system, and shown with a fire hose of a fire truck coupled to the FDC.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

### Definitions

The term “fire department connection” or “FDC” refers to a fitting with an inlet and an outlet. In one aspect, the FDC can have two inlets. The inlet(s) can be female inlet(s) with swivel fittings with internal threads to connect to fire department hoses. Thus, the FDC can have at least one female swivel connection for connecting to a fire hose. The swivel fitting(s) and/or femal inlet(s) can be a standard 2½″ size to couple to standard fire hoses with 2½″ male fittings with external threads. The fire department hoses can be coupled to a pumper truck with its own water tank and pump, and/or with a connection to a fire hydrant. In another aspect, the FDC can have a flapper valve or clapper between the two inlets to close one inlet if only the other inlet is coupled to a hose.

The term “quick-connect” or “quick-connection” refers to a releasable or removable connection between the FDC and an inlet to a fire sprinkler and/or standpipe system of a building. In one aspect, the quick-connection can be hand-connected or hand-tightened without the use of additional tools. In another aspect, the quick-connection carries a seal or gasket to resist leaks between the FDC and the inlet so that the connection can be made without solder, pipe tape, or even pipe threads.

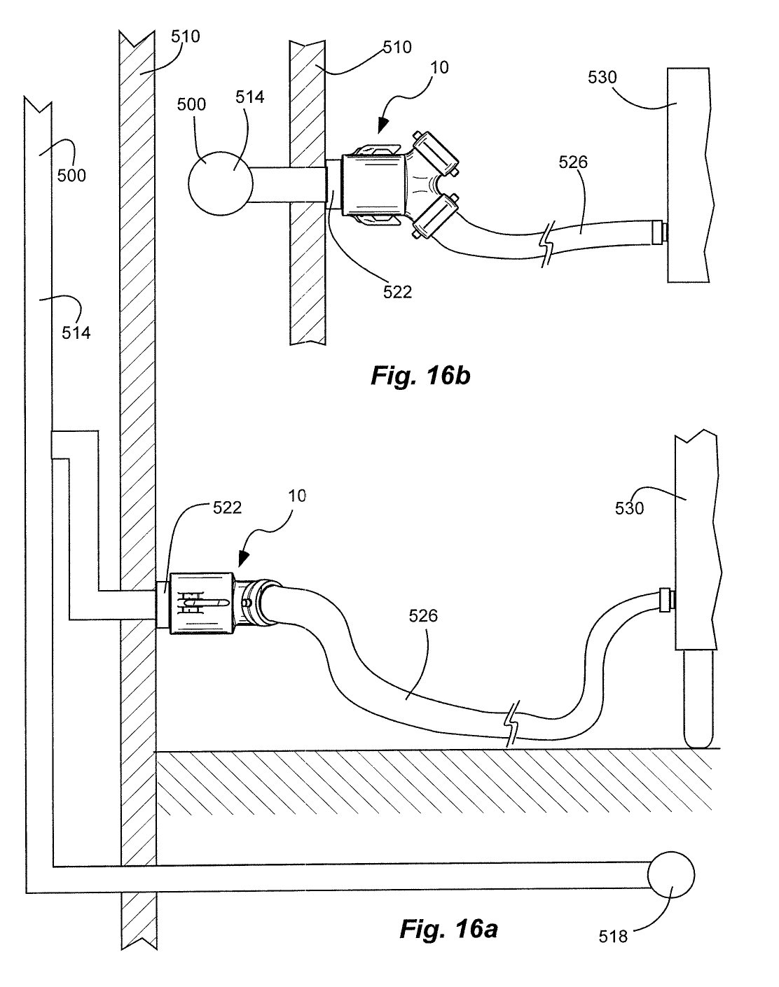

The term “fire sprinkler system” and/or “standpipe system” refers to water distribution system built into a building to distribute water for fire suppression. An example of a fire sprinkler and/or standpipe system 500 of a building 510 is shown in FIGS. 16a and 16b. The water distribution system can comprise a pipe network 514 through the building 510 with fire sprinkler heads. The water distribution system is typically coupled to a municipal water system 518 that can be located underground. In addition, the water distribution has an inlet 522 to the system that extends outside the building 510 for ready access by the fire department. The building inlet 522 can extend horizontally from a wall of the building 510, as shown, or can extend vertically from the ground adjacent to the building. The inlet 522 is used by the fire department to add water to the water distribution system to supplement the system in case the municipal water system is inadequate. The fire department can connect fire hoses 526 to the inlet 522, and to another water supply, such as a firehydrant and/or a tank on a fire truck 530. The building inlet 522 can be a pipe with a standard, predetermined size based on the size of the fire suppression system and/or building, such as 6″, 4″, 2½″ or 1½″. The 6″ and 4″ sizes can be appropriate for commercial buildings, while the 2½″ or 1½″ sized can be appropriate for residential buildings.

### DESCRIPTION

A fire department connection (FDC) device, system and method, in example implementations in accordance with the invention are shown in the attached drawings. The FDC can be carried by the fire department, such as on a pumper truck, and transported to a building. The building can have an inlet or building inlet to a fire sprinkler and/or standpipe system. A check valve can be positioned between the building inlet and the fire sprinkler and/or standpipe system. In one aspect, the building inlet can be a pipe or stem with a standard, predetermined size (e.g. 6″, 4″, 2½″ or 1½″), and can have a portion of a quick-connect, such as an annular groove or an annular channel formed in an exterior of the pipe and circumscribing the pipe, defining a plug. A cap can cover the open end of the pipe, and can be secured with a lock, such as a Knox lock, to resist tampering and/or debris. In one aspect, the cap can have a quick connect similar to those described herein, with a lock, such as locking arms. When the lock and the cap are removed from the building inlet by the fire department, the FDC can be releasably and quickly coupled to the building inlet with a quick-connect. The FDC can have a collar defining a socket to receive the plug. In one aspect, the FDC can be coupled to the building inlet by a single firefighter. In another aspect, the FDC can be coupled to the building inlet manually, or without tools. A fire hose can be coupled to the FDC and a water source, such as a pumper truck and/or fire hydrant, to supplement the building fire sprinkler and/or standpipe system. When finished, the FDC can be removed from the building inlet and taken with the fire department. Thus, the FDC is continuously in custody of the fire department to resist theft and/or damage. Keeping the FDC in the custody of the fire department prevents an unattended FDC, and the opportunity for theft and/or damage.

The FDC can comprise a housing with at least one inlet and an outlet. The outlet can be configured with another portion of a quick-connect to couple to the quick-connect of the building inlet. The inlet of the housing can have a hose fitting capable of being removably coupled to a fire hose. In one aspect, the inlet of the housing can have a swivel fitting. In another aspect, the housing can have a pair of inlets. In one aspect, the housing can be formed of or can comprise brass, and can be formed by casting. In another aspect, the housing can be formed of or can comprise aluminum, and can also be formed by casting. In another aspect, the housing can be formed of another non-ferrous metal or material. At least a portion of the quick-connect can be formed with or cast with the housing of the FDC.

A quick-connect can be disposed on the outlet of the housing, and the building inlet, to releasably couple the housing and the outlet thereof (and thus the FDC) to the building inlet of a building fire sprinkler and/or standpipe system. As described above, a portion of the quick-connect can be formed on the building inlet, and another portion of the quick-connect can be formed on the outlet of the housing or FDC. The portions of the quick-connect on the outlet of the housing (or FDC) and the inlet of the building can comprise annular grooves or annular channels circumscribing the outlet of the housing and the building inlet. In another aspect, the quick-connect can comprise another portion (or third portion) to join the portions of the building inlet and the housing outlet. In one aspect, the quick-connect can comprise a female quick-connect capable of receiving a male quick-connect of the building inlet. In another aspect, the quick-connect on the FDC can comprise a female quick-connect permanently carried by the housing of the FDC. Thus, the another or third portion of the quick-connect can be carried by and affixed to the housing or FDC. Thus, the FDC has no loose parts that can be misplaced. In addition, the quick-connect can be part of the FDC, and can be carried by the fire department along with the FDC. As described above, the quick-connect can be manually operated, and capable of coupling to and releasing from the building inlet without tools.

In one aspect, the quick-connect can be or can comprise a cam lock. The cam lock can comprise one or more cams pivotally coupled to the housing at the outlet. In one aspect, the cams can comprise a pair of cams on opposite sides of the outlet. The cams can be capable of pivoting into and out of a groove in the building inlet. One or more arms can be fixed to the one or more cams, and can be capable of pivoting the cams. Thus, in use, the FDC or outlet of the fitting can be inserted over the building inlet so that an annular groove in the building outlet is received in the outlet of the fitting. The arms can be pivoted to pivot the cams so that a lobe of each cam pivots into the groove, thus locking the FDC to the building inlet. The arms can be locked or held in place, such as with a pin or ring. In addition, the FDC or housing can also have an outlet seal with a gasket between an inner flange of the fitting and the building inlet to resist leaking. Pivoting the cams can draw the FDC or fitting into the building inlet to compress the housing.

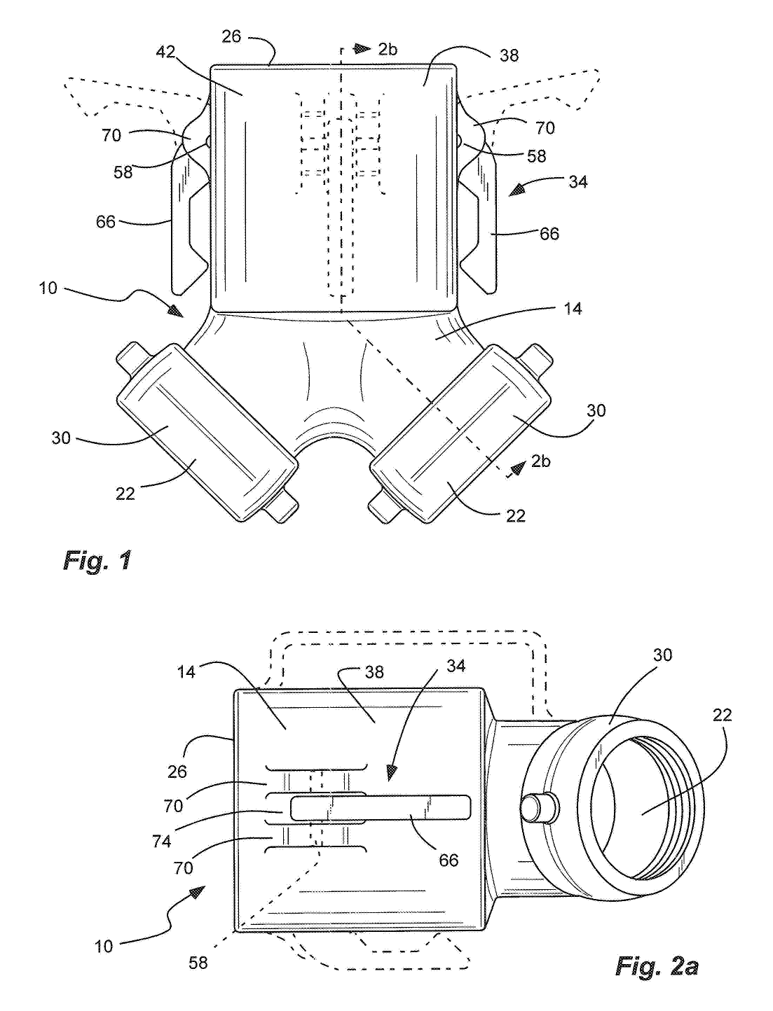

Referring to FIGS. 1-3b, an FDC device, indicated generally at 10, in accordance with an exemplary embodiment is shown. The FDC 10 comprises a housing 14 or body with a hollow 18 therethrough. The housing 14 has one or more inlets 22 at one end of the hollow 18 and/or housing, and an outlet 26 at another end of the hollow and/or housing. In one aspect, the FDC 10 and/or the housing 14 can have a pair of, or dual, inlets 22, as shown. In another aspect, the FDC can have a single inlet, as described below. The housing 14 and/or the inlet 22 can have a female swivel fitting 30 at the inlet to be removably coupled to a fire hose 526 (FIGS. 16a and 16b). In one aspect, the inlet 22 and the swivel fitting 30 can have internal screw threads and a 2½″ internal diameter size to fit a standard 2½″ external diameter and external screw threads of the fire hose fitting. Thus, the fire hose fitting can be inserted into the swivel fitting 30, and the swivel fitting rotated to connect the fire hose to the FDC and housing, as shown in FIGS. 16a and 16b. The housing 14, including the inlets 22 and the outlet 26, can be formed of, or can comprise, brass, and can be formed by casting. Similarly, the swivel fittings 30 can be formed of, or can comprise, brass, and can be rotatably disposed on the housing 14 at the inlets 22.

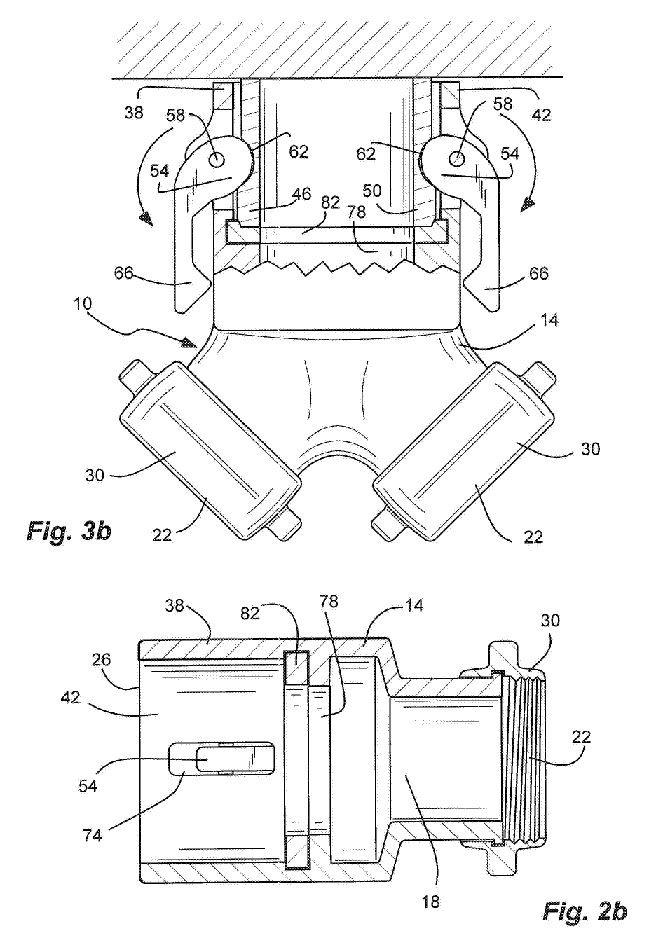

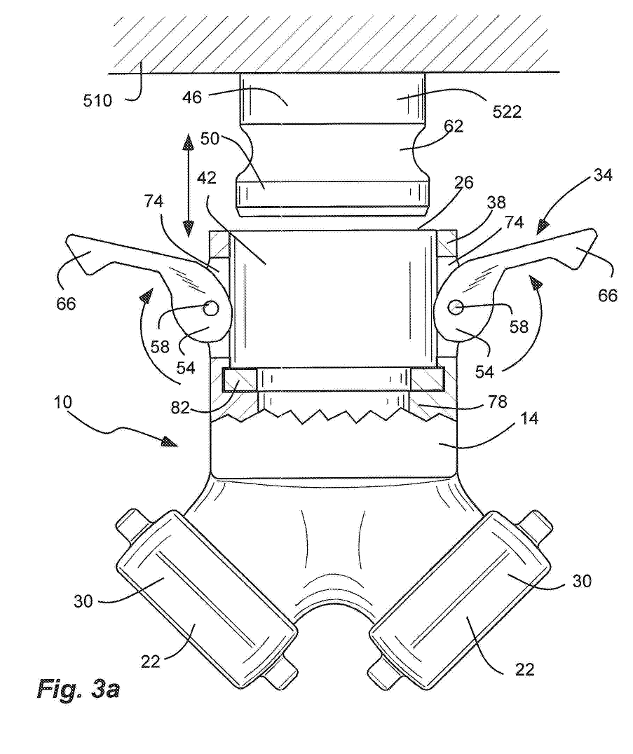

In addition, the FDC 10 and/or the housing 14 comprises a quick-connect 34, or portion thereof, disposed on and carried by the outlet 26 of the housing 14. The quick-connect 34 is capable of releasably coupling the outlet 26 of the housing 14 to a building inlet 522 of a building fire sprinkler and/or standpipe system 500 (FIGS. 16a and 16b), as shown in FIG. 3b. In one aspect, the housing 14 and/or the quick-connect 34 can comprise a collar 38 (FIGS. 2b and 3a) extending from the housing 14 at the outlet 26. The collar 38 defines a socket 42 of the quick-connect 34 that is capable of receiving a stem 46 (FIG. 3a) of the building inlet 522. The stem 46 of the building inlet 522 defines a plug 50 of the quick-connect 34. In one aspect, the quick-connect 34, or portion thereof (e.g. the collar 38 and the socket 42), can be permanently affixed to and carried by the housing 14. The quick-connect 34, or a stationary portion thereof (e.g. the collar 38 and the socket 42), can be formed along with the housing 14 so that the stationary portion of the quick-connect 34 and the housing 14 form a solid, continuous, single, unitary or monolithic housing.

As described above, the quick-connect 34 can be manually operated, and can be capable of coupling to and releasing from the building inlet 522, or the stem 46 and the plug 50 thereof, without tools and without pipe threads. Thus, the collar 38 and the socket 42 can be slid linearly over the stem 46 and the plug 50 quickly and easily, without rotation and without tools.

In one aspect, the quick-connect 34 can comprise a cam lock type quick-connect with a cam 54 pivotally affixed to the collar 38 and/or socket 42 of the housing 14. The cam 54 can pivot about a pivot or axle 58 carried by the collar 38 and/or socket 42. Thus, the cam 54 is movably disposed in the collar 38 and the socket 42. In addition, the cam 54 is capable of pivoting into and out of a groove 62 in the stem 46 and/or the plug 50 of the building inlet 522. Thus, the quick-connect 34, or portion thereof, namely the groove 62, can be disposed on or carried by the building inlet 522, or stem 46 and plug 50 thereof. In one aspect, the groove 62 can be an annular groove, as shown, and can circumscribe the stem 46. In another aspect, the groove can be multiple grooves each corresponding to a cam. In one aspect, the groove 62 can have a curved or acruate profile or cross-section to match and mate with the profile or cross-section of the cam. The cam 54 can pivot between an open or unlocked position in which the cam is disposed out of the groove 62, as shown in FIG. 3a, and a closed or locked position in which the cam is disposed in the groove 62, as shown in FIG. 3b. The quick-connect 34 can also comprise an arm 66 fixed to the cam 54 and capable of pivoting the cam between the open/unlocked and closed/locked positions. The axle 58 can be carried between a pair of lobes 70 extending from the collar 38 and the socket 42. The lobes 70 can be cast with the housing, and can be part of the solid, continuous, single, unitary or monolithic housing. Thus, a portion of the quick-connect 34 is part of the solid, continuous, single, unitary or monolithic housing. A slot 74 is formed between the pair of lobes 70 and through the collar 38 and the socket 42. The cam 54 extends through the slot 70 and into the socket 42.

In one aspect, the quick-connect 34 can comprise a pair of cam lock type quick-connects, with a pair of cams 54 and associated arms 66, on opposite sides of the collar 38 and the socket 42 of the housing 14. In one aspect, the pair of cam lock type quick-connects can be disposed on lateral sides of the collar 38 and the socket 42, as shown. Positioning the quick-connects on lateral sides can make the arms 66 easier to engage and disengage. In another aspect, the pair of cam lock type quick-connects can be disposed on the top and bottom of the collar and the socket, as shown in dashed lines in FIGS. 1 and 2a.

In another aspect, the FDC 10 comprises an outlet seal to seal the outlet 26, and/or collar 38 of the socket 42, of the housing 14 with the building inlet 522, or the stem 46 of the plug 50, as shown in FIG. 3b. The outlet seal can comprise an interior annular flange 78 disposed in the outlet 26 of the housing 14. In addition, the outlet seal can comprise a gasket 82 disposed in the outlet 26 of the housing 14 adjacent the interior annular flange 78. The gasket 82 abuts to the building inlet 522, or the stem 46 of the plug 50 thereof, of the building fire sprinkler and/or standpipe system 500. The gasket 82 can be compressed between the stem 46 of the building inlet 522 and the flange 78 of the FDC.

As indicated above, the quick-connect 34 can comprise a portion carried by the FDC and a portion carried by the building inlet 522. The building inlet 522 comprises the stem 46 with the groove 62 therein, defining the plug 50. While the FDC 10 comprises the collar 38 with the cam(s) 54 and the arm(s) 66, defining the socket 42.

The FDC 10 has two configurations or positions, including an installed or use configuration on the building inlet 522, as shown in FIG. 3b, and an uninstalled or storage configuration off of the building outlet 522, as shown in FIG. 3a. The quick-connect 34 allows the FDC to be rapidly moved or transitioned between the installed/use configuration and the uninstalled/storage configuration. The FDC 10 can be releasably and quickly coupled to the building inlet 522 with the quick-connect 34. In one aspect, the FDC 10 can be coupled to the building inlet 522 by a single firefighter. In another aspect, the FDC 10 can be coupled to the building inlet 522 manually, or without tools. When finished, the FDC 10 can be removed from the building inlet 522 and taken with the fire department. Thus, the FDC is continuously in custody of the fire department to resist theft and/or damage. Keeping the FDC in the custody of the fire department prevents an unattended FDC, and the opportunity for theft and/or damage. In another aspect, the quick-connect 34, or a portion thereof, can be permanently carried by the FDC 10. Thus, the FDC 10 has no loose parts that can be misplaced. The quick-connect 34, or portion carried thereby, can be part of the FDC 10, and can be carried by the fire department along with the FDC.

In one aspect, the FDC can have a handle as shown in dashed lines in FIG. 2a to facilitate carrying the FDC.

The invention also provides a method for providing supplemental water to a building 510 with a building inlet 522 to a fire sprinkler and/or standpipe system 500, and/or for using the FDC 10 described above. The method comprises carrying a fire department connection (FDC) 10 on a pumper truck 530 (FIGS. 16a and 16b) having a water tank, a pump, and a hose 526. The method also includes transporting the FDC 10 on the pumper truck 530 to the building 510 with the building inlet 522 to the fire sprinkler and/or standpipe system 500, as shown in FIGS. 16a and 16b. The method further includes removing the FDC 10 from the pumper truck 530, and removably coupling the outlet 26 of the FDC to the building inlet 522 with a quick-connect 34, as described above. The method also includes coupling the hose 526 between the pumper truck 530 and the at least one inlet 22 of the FDC 10, and pumping water from the truck 530, through the hose 526 and the FDC, to the fire sprinkler and/or standpipe system 500 of the building 510, as shown in FIGS. 16 and 16b. The method further comprises removing the FDC 10 from the building inlet 522, and replacing the FDC on the pumper truck 530. Thus, the FDC remains continuously in custody of the fire department to resist theft and tampering.

In one aspect, removably coupling the outlet 26 of the FDC 10 to the building inlet 522, and removing the FDC from the building inlet, can comprise manually operating the quick-connect 34 without tools. Thus, the FDC can be rapidly deployed without interference or complications.

As described above, at least a portion of the quick-connect 34 can be permanently affixed to, and carried by, the housing 14 of the FDC 10. Thus, in one aspect, the method can also comprise carrying, transporting, removing and replacing the at least a portion of the quick connect 34 along with the FDC 10.

In one aspect, removably coupling the outlet of the FDC to the inlet of the building can further comprise sliding the collar 38 of the FDC 10 over the stem 46 of the building inlet 522. Thus, the FDC can be coupled to the building inlet without revolving the FDC.

In another aspect, removably coupling the outlet 26 of the FDC 10 to the building inlet can further comprise pivoting the cam 54 into the groove 62 of the stem 46 of the building inlet 522. Similarly, removing the FDC 10 from the building inlet 522 can comprise pivoting the cam 54 out of the groove 62 of the stem 46 of the building inlet 522.

As described above, the FDC can comprise an interior annular flange 78 and a gasket 82. Thus, removably coupling the outlet 26 of the FDC 10 to the building inlet 522 can further comprise abutting the building inlet 522, or stem 46 thereof, to the gasket 78 in the outlet of the housing of the FDC.

As indicated above, the building inlet 522 may have different sizes for different buildings. For example, the building inlet 522 can be 6″, 4″, 2½″ or 1½″. Thus, in one aspect, the fire department can carry several different FDCs as described above, but each with a different size outlet to match the different possible sized of building inlets.

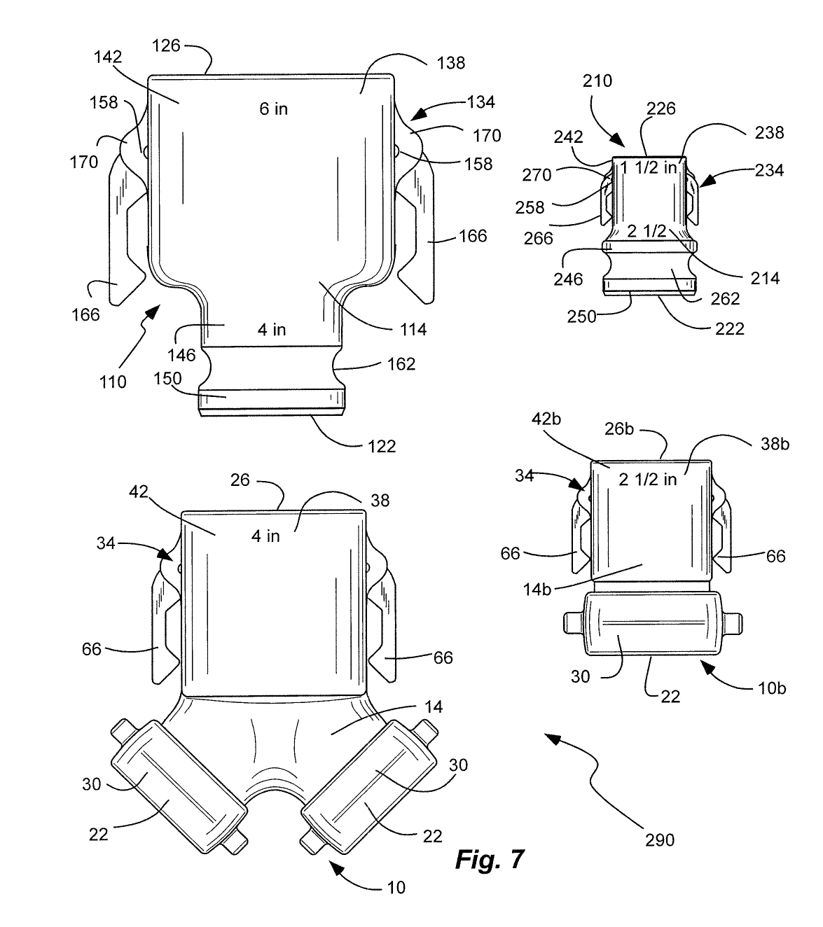

Referring to FIG. 7, an FDC 10b in accordance with an exemplary embodiment is shown. The FDC 10b can be a smaller, while the FDC 10 described above can be larger. The FDC 10b can be similar in most respect to the FDC 10 described above, and which description is hereby incorporated by reference. The FDC 10b comprises a housing 14b with a single inlet 22 at one end of the housing, and an outlet 266 at another end. In addition, the FDC 10b and/or the housing 14b comprises a quick-connect 34, or portion thereof, with a collar 38b defining a socket 42b that is capable of receiving a smaller stem 46 of a smaller plug 50 of a smaller building inlet 522. The quick-connect 34 can comprise a cam lock type quick-connect, as described above.

In another aspect, the FDC 10 described above can be provided with an adaptor to convert the FDC from one size to another, to define an FDC system, or part of an FDC system. In one aspect, the adaptor can be an enlarging adaptor from a smaller FDC to a larger building inlet. In one aspect, the adaptor can couple a larger building inlet to a smaller outlet of an FDC. For example, the adaptor can couple a 6″ building inlet to a 4″ FDC. Thus, the 4″ FDC and the adaptor can form an FDC system where the 4″ FDC can be used with both a 6″ building inlet with the adaptor, and a 4″ building inlet by itself.

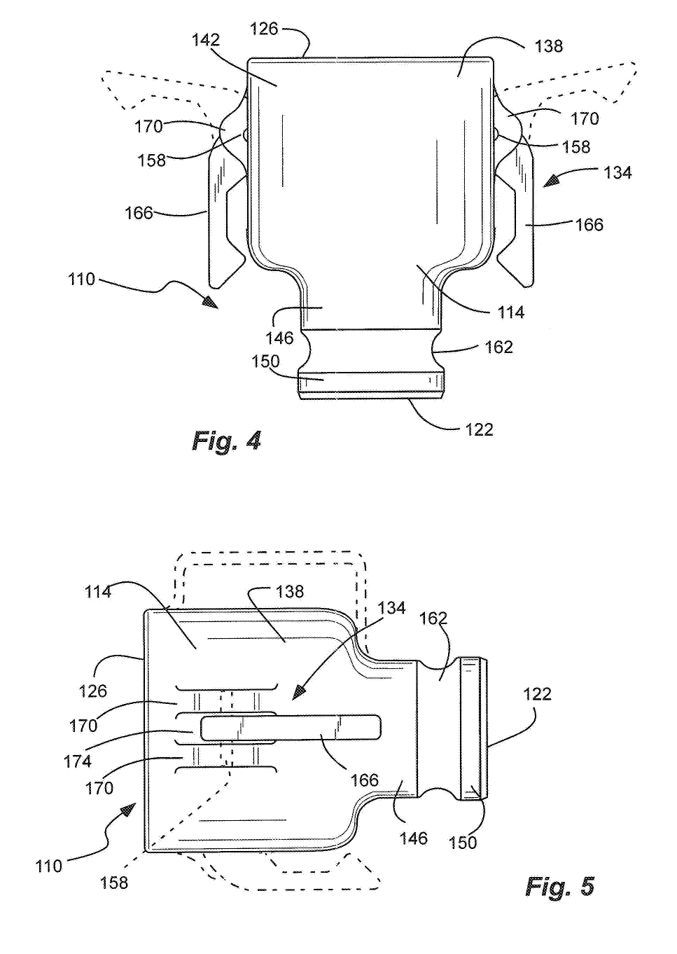

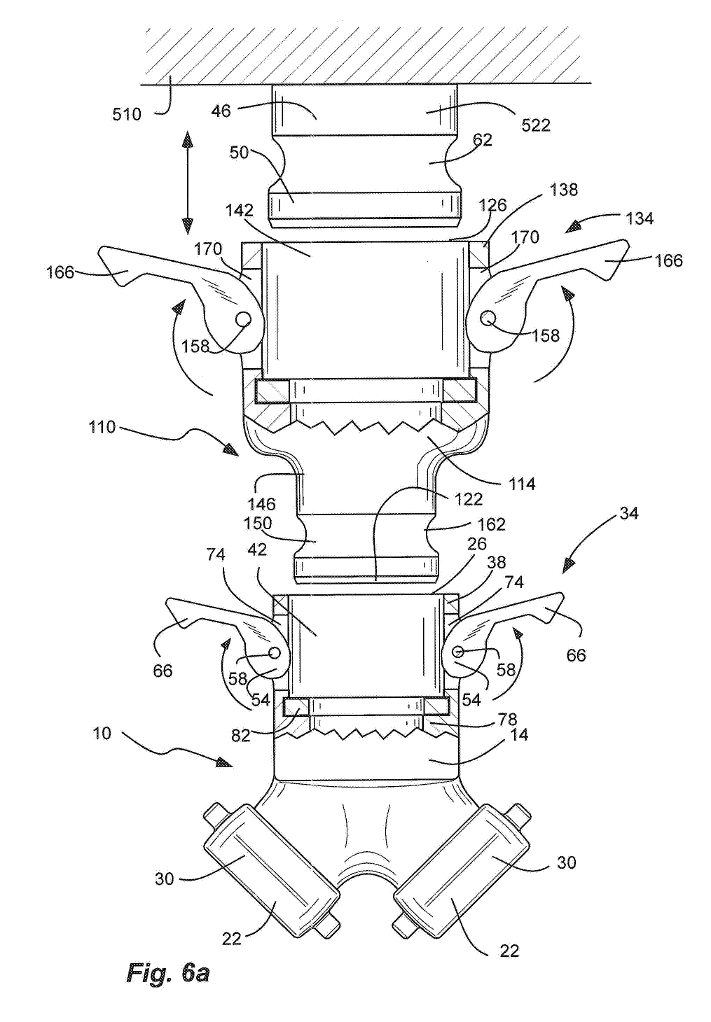

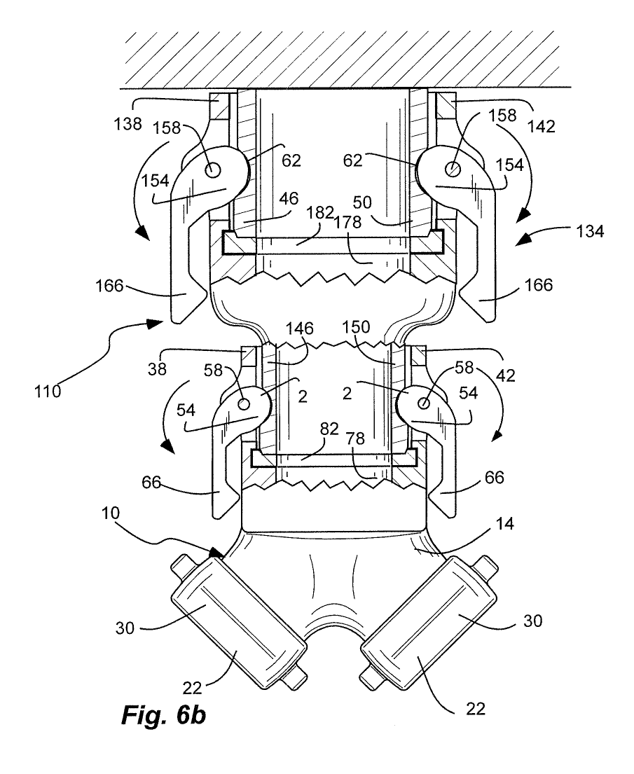

Referring to FIGS. 4-6b, an adaptor 110 in accordance with an exemplary embodiment is shown. The adaptor can be an enlarging adaptor, or an enlarger. The adaptor 110 comprises an adaptor fitting 114 with a smaller inlet 122 (for the smaller FDC) and a larger outlet 126 (for the larger building inlet). In addition, the adaptor 110 comprises an adaptor quick-connect 134 carried by the adaptor fitting 114 to removably couple the larger outlet 126 of the adaptor to the building inlet 522. The adaptor quick-connect 134 can be similar to, or even the same as, the quick-connect 34 described above. In addition, the adaptor 110 and/or the adaptor fitting 114 comprises a plug 150 with a stem 146 and a groove 162 in the stem 146. The plug, and the sterm 146 and the groove 162, of the adaptor 110 can be similar to, or the same as, the plug 50 described above, and can be a plug 150 of the quick-connect 34 of the FDC 10. The quick connect 34 of the outlet 26 of the housing 14 of the FDC 10 can releasably couple the outlet 26 of the housing 14 of the FDC 10 to the smaller inlet 122 of the the adaptor 110. Thus, the outlet 26 of the housing 14 of the FDC 10 is removably coupled to the building inlet 522 via the adaptor 110, as shown in FIG. 6b.

As indicated above, the adaptor quick-connect 134 can be similar to, or even the same as, the quick-connect 34 described above. The adaptor 110 and/or the adaptor quick-connect 134 can comprise a collar 138 extending from the adaptor fitting 114 at the outlet 126. The collar 138 defines a socket 142 of the adaptor quick-connect 134 that is capable of receiving a stem 46 of the building inlet 522. The adaptor quick-connect 134 can be manually operated, and can be capable of coupling to and releasing from the building inlet 522, or the stem 46 and the plug 50 thereof, without tools and without pipe threads. The adaptor quick-connect 134 can comprise a cam lock type quick-connect with a cam 154 pivotally affixed to the collar 138 and/or the socket 142 of the adaptor fitting 114. The cam 154 can pivot about a pivot or axle 158 carried by the collar 138 and/or the socket 142. In addition, the cam 154 is capable of pivoting into and out of the groove 62 in the stem 46 and/or the plug 50 of the building inlet 522. The cam 154 can pivot between an open or unlocked position in which the cam is disposed out of the groove 62, as shown in FIG. 6a, and a closed or locked position in which the cam is disposed in the groove 62, as shown in FIG. 6b. The quick-connect 134 can also comprise an arm 166 fixed to the cam 154 and capable of pivoting the cam between the open/unlocked and closed/locked positions. The axle 158 can be carried between a pair of lobes 170 extending from the collar 138 and the socket 142. The plug 150 and the socket 142, or the stem 146 and the collar 138, of the adaptor 110 or the adaptor fitting 114 can be a solid, continuous, single, unitary or monolithic housing, and can be cast together in a single casting. A portion of the adaptor quick-connect 134 is part of the solid, continuous, single, unitary or monolithic housing. A slot 174 is formed between the pair of lobes 170 and through the collar 138 and the socket 142. The cam 154 extends through the slot 170 and into the socket 142. In one aspect, the adaptor quick-connect 134 can comprise a pair of cam lock type quick-connects, with a pair of cams 154 and associated arms 166, on opposite sides of the collar 138 and the socket 142 of the adaptor fitting 114. In one aspect, the pair of cam lock type quick-connects can be disposed on lateral sides of the collar 138 and the socket 142, as shown.

In addition, the FDC can have a handle coupled to the housing, as shown in dashed lines in FIG. 2a, to facilitate carrying and handling the FDC. The handle can be formed with the housing.

In another aspect, the method can further comprise carrying an adaptor fitting 110 with an inlet 122 and an outlet 126, such as a smaller inlet and a larger outlet, on the pumper truck; transporting the adaptor 110 on the pumper truck 310 to the building 510; removing the adaptor 110 from the pumper truck; removably coupling the (larger) outlet 126 of the adaptor 110 to the building inlet 522 with an adaptor quick-connect 134; removably coupling the outlet 26 of the FDC 10 to the (smaller) inlet 122 of the the adaptor 110 with the quick-connect 34, thus removably coupling the outlet of the FDC 10 to the building inlet via the adaptor 100; removing the adaptor 110 from the building inlet 522; and replacing the adaptor 11 on the pumper truck, along with the FDC.

In another aspect, the adaptor can be an reducing adaptor from a larger FDC to a smaller building inlet. In another aspect, the adaptor can coupled a smaller building outlet with a larger outlet of an FDC. For example, the adaptor can coupled a 1½″ building outlet to a 2½″ FDC. Thus, the FDC and the adaptor can form an FDC system where the 2½″ FDC can be used with both a 1½″ building inlet with the adaptor, and a 2½″ building inlet by itself.

Referring to FIG. 7, an adaptor 210 in accordance with an exemplary embodiment is shown. The adaptor 210 can be a reducing adaptor, or a reducer. The adaptor 210 can be similar in most respect to the adaptor 110 described above, and which description is hereby incorporated by reference. The adaptor 210 comprises an adaptor fitting 214 with a larger inlet 222 (for the larger FDC 10b) and a smaller outlet 226 (for the smaller building inlet). In addition, the adaptor 210 comprises an adaptor quick-connect 234 carried by the adaptor fitting 214 to removably couple the smaller outlet 226 of the adaptor to the building inlet 522. The adaptor quick-connect 234 can be similar to, or even the same as, the quick-connect 34 described above. In addition, the adaptor 210 and/or the adaptor fitting 214 comprises a plug 250 with a stem 246 and a groove 262 in the stem 246. The plug 250, and the sterm 246 and the groove 262, of the adaptor 210 can be similar to, or the same as, the plug 50 described above, and can be a plug 250 of the quick-connect 34 of the FDC 10b. The quick connect 34 of the outlet 26b of the housing 14b of the FDC 10b can releasably couple the outlet 26b of the housing 14b of the FDC 10b to the smaller inlet 222 of the the adaptor 210. Thus, the outlet 26b of the housing 14b of the FDC 10b is removably coupled to the building inlet 522 via the adaptor 210, as shown in FIG. 7.

As indicated above, the adaptor quick-connect 234 can be similar to, or even the same as, the quick-connect 34 described above. The adaptor 210 and/or the adaptor quick-connect 234 can comprise a collar 238 extending from the adaptor fitting 214 at the outlet 226. The collar 238 defines a socket 242 of the adaptor quick-connect 234 that is capable of receiving a stem 46 of the building inlet 522. The adaptor quick-connect 234 can be manually operated, and can be capable of coupling to and releasing from the building inlet 522, or the stem 46 and the plug 50 thereof, without tools and without pipe threads. The adaptor quick-connect 234 can comprise a cam lock type quick-connect with a cam 254 pivotally affixed to the collar 238 and/or the socket 242 of the adaptor fitting 214. The cam 254 can pivot about a pivot or axle 258 carried by the collar 238 and/or the socket 242. In addition, the cam 254 is capable of pivoting into and out of the groove 62 in the stem 46 and/or the plug 50 of the building inlet 522. The cam 254 can pivot between an open or unlocked position in which the cam is disposed out of the groove 62, and a closed or locked position in which the cam is disposed in the groove 62. The quick-connect 234 can also comprise an arm 266 fixed to the cam 254 and capable of pivoting the cam between the open/unlocked and closed/locked positions. The axle 258 can be carried between a pair of lobes 270 extending from the collar 238 and the socket 242. The plug 250 and the socket 242, or the stem 246 and the collar 238, of the adaptor 210 or the adaptor fitting 214 can be a solid, continuous, single, unitary or monolithic housing, and can be cast together in a single casting. A portion of the adaptor quick-connect 234 is part of the solid, continuous, single, unitary or monolithic housing. A slot is formed between the pair of lobes 270 and through the collar 238 and the socket 242. The cam 254 extends through the slot and into the socket 242. In one aspect, the adaptor quick-connect 234 can comprise a pair of cam lock type quick-connects, with a pair of cams 254 and associated arms 266, on opposite sides of the collar 238 and the socket 242 of the adaptor fitting 214. In one aspect, the pair of cam lock type quick-connects can be disposed on lateral sides of the collar 238 and the socket 242, as shown.

In addition, the adaptor can have a handle coupled to the fitting, as shown in dashed lines in FIG. 5, to facilitate carrying the adaptor.

Also shown in FIG. 7 is an FDC system 290 with multiple FDCs and multiple adaptors, including a pair of FDCs and a pair of adaptors. The pair of FDCs can comprise a larger FDC 10, such as a 4″ FDC, and a smaller FDC 10b, such as a 2½“FDC. The pair of adaptors can comprise a larger adaptor or enlarging adaptor 110, such as a 4″ to 6″ adaptor, and a smaller adaptor or a reducing adaptor 210, such as a 2½″ to a 1½” adaptor.

As described above, the FDC 10 and 10b can have a quick connect 34. In one aspect, the quick connect 34 can be a cam lock type quick-connect, as described above. In addition, the adaptors 110 and 210 can also have a quick connect 134 and 234, which also can be cam lock type quick-connects, as described above. In another aspect, the FDCs 10 and 10b and the adaptors 110 and 210 can have another type of quick-connect, some of which are described below by way of example. The quick connect of the FDCs and/or adaptors can have one or more cams, balls or pins, carried by the collar and displaceable radially inwardly to be received within an annular groove 62 or channel of stem 46 and/or the plug 50 of the building inlet 522, and displaceable radially outwardly to be disposed out of the annular groove 62 or channel of the stem 46 and/or the plug 50 of the building inlet 522.

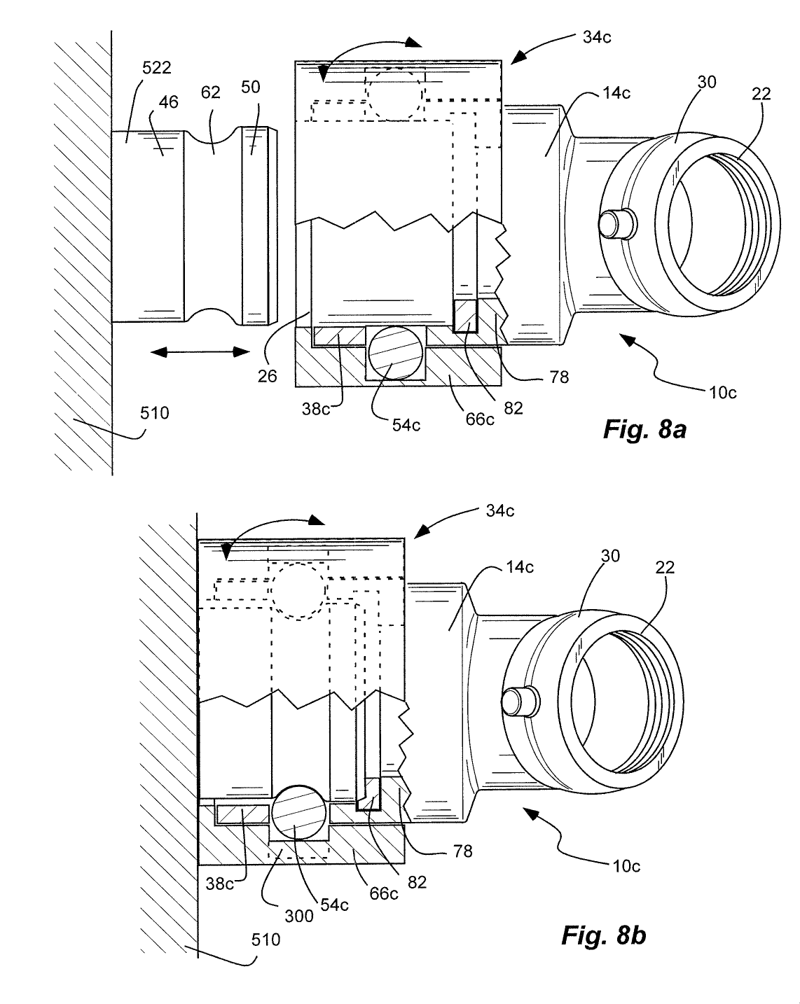

Referring to FIGS. 8a and 8b, another FDC 10c is shown that is similar in most respects to those described above, and which description is hereby incorporated herein by reference. The FDC 10c has a quick-connect 34c that can be or can comprise a twist-bearing lock. The twist lock can comprise a collar or an annular bearing carriage 38c extending from the housing 14c. Bearings 54c can be carried by the annular bearing carriage 38c, such as in holes disposed around the bearing carriage. Thus, the bearings 54c can be disposed around or can circumscribe the bearing carriage, and thus the building inlet. The bearings 54c can be capable of displacing into and out of the groove 62 in the building inlet 522. The holes in the bearing carriage 38c can be tapered or reduced at the inside to prevent the bearings 54c from passing out of the holes. A sleeve 66c can be disposed around and carried by the bearing carriage 38c. In addition, the sleeve 66c can be pivotal around the bearing carriage 38c. Tabs 300 can be disposed on an inside of the sleeve 66c, and can correspond in number and location to the bearings 54c. The tabs 300 can be inclined, or can have an inclined ramp adjacent the tabs. The tabs 300 can be capable of displacing the bearings 54c into and out of the groove 62 in the building inlet 522 as the sleeve 66c pivots on the bearing carriage 38c. Thus, twisting the sleeve 66c can position the tabs 300 behind the bearings 54c, displacing the bearings 54c into the groove 62 of the building inlet 522, defining a locked orientation of the sleeve 66c and the quick-connect 34c, as shown in FIG. 8b. Twisting the sleeve 66c back can remove the tabs 300 from behind the bearings 54c, allowing the bearings 54c to displace out of the groove 62 of the building inlet 522. In one aspect, the bearings 54c can be biased inwardly. In another aspect, the sleeve 66c can be biased in the locked orientation.

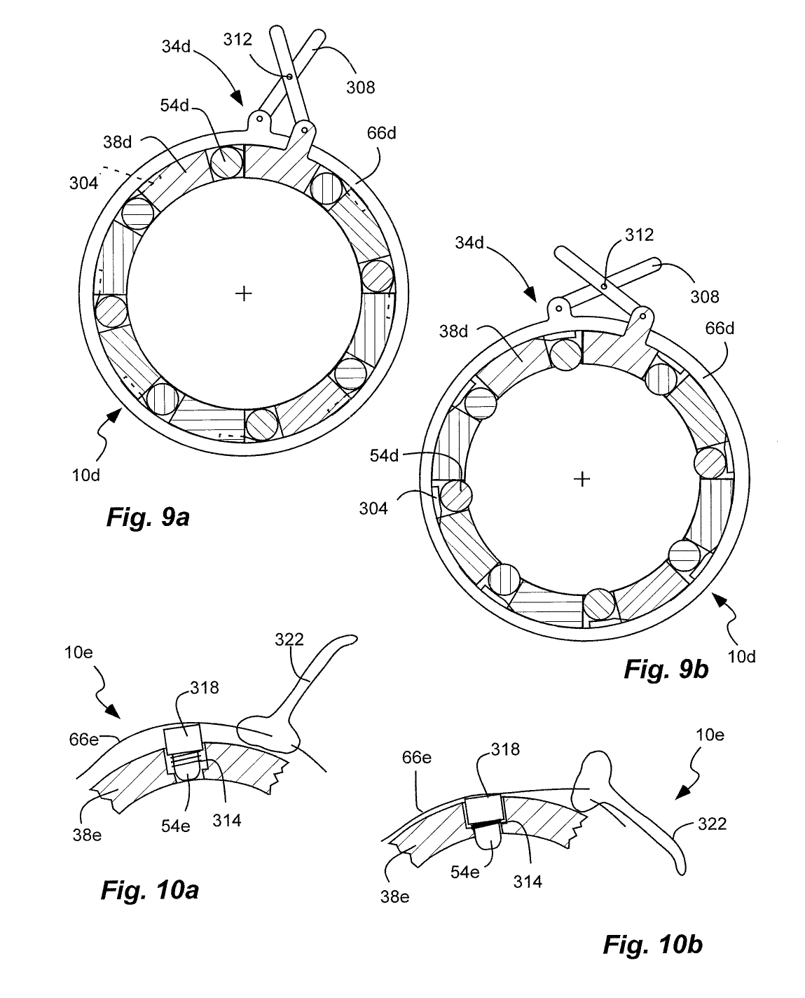

Referring to FIGS. 9a and 9b, another FDC 10d is shown that is similar in most respects to those described above, and which description is hereby incorporated herein by reference. The FDC 10d has a quick-connect 34d that can be or can comprise a scissor-bearing lock. The scissor-bearing lock can be similar to the twist-bearing lock, described above, but with a scissor arm actuator or mechanism. The scissor-bearing lock can comprise a collar or an annular bearing carriage 38d extending from the housing. Bearings 54d can be carried by the annular bearing carriage 38d, such as in holes disposed around the bearing carriage. Thus, the bearings 54d can be disposed around or can circumscribe the bearing carriage 38d, and thus the building inlet. The bearings 54d can be capable of displacing into and out of the groove in the building inlet. A lock ring 66d can be disposed around the bearing carriage 38d. In addition, the lock ring 66d can pivot around the bearing carriage 38d. Tabs 304 can be disposed on an inside of the lock ring 66d, and can correspond in number and location to the bearings 54d. The tabs 304 can be inclined, or can have an inclined ramp adjacent the tabs. The tabs 304 can be capable of displacing the bearings 54d into and out of the groove in the building inlet as the lock ring 66d pivots on the bearing carriage 38d. Thus, pivoting or rotating the lock ring 66d can position the tabs 304 behind the bearings 54d, displacing the bearings 54d into the groove of the building inlet, defining a locked orientation of the lock ring 66d and the quick-connect 34d. Pivoting or rotating the lock ring 66d back can remove the tabs 304 from behind the bearings 54d, allowing the bearings 54d to displace out of the groove of the building inlet. In one aspect, the bearings can be biased inwardly. Scissor arms 308 can be coupled together at a pivot 312, and can be pivotally coupled to and between the bearing carriage 38d and the lock ring 66d at pivots. The scissor arms 308 can be capable of pivoting the lock ring 66d with respect to the bearing carriage 38d. In one aspect, the scissor arms can be biased or locked in the lock position.

Referring to FIGS. 10a and 10b, another FDC 10e is shown that is similar in most respects to those described above, and which description is hereby incorporated herein by reference. The FDC 10e has a quick-connect 34e that can be or can comprise a pin-strap lock. The pin-strap lock can comprise an annular pin carriage 38e extending from the housing. Pins 54e can be carried by the annular pin carriage 38e, such as in holes disposed around the carriage. Thus, the pins 54e can be disposed around or can circumscribe the carriage 38e, and thus the building inlet. The pins 54e can be spring-loaded in an outward direction, such as by a spring 314 between the annular pin carriage 38e and an enlarged head 318. The pins 54e can be capable of displacing into and out of a groove in the building inlet. A lock band 66e can be disposed around the annular pin carriage 38e. The lock band 66e can be expandable and contractible to displace the pins 54e into and out of the groove in the building inlet as the lock band expands and contracts. A lock lever 322 can be coupled to the lock band 66e to expand and contract the lock band. The lock lever 322 can fill a gap in the band 66e such that turning the lock lever shortens the band, tightening the band around the annular pin carriage 38e and displace the pins 54e inwardly.

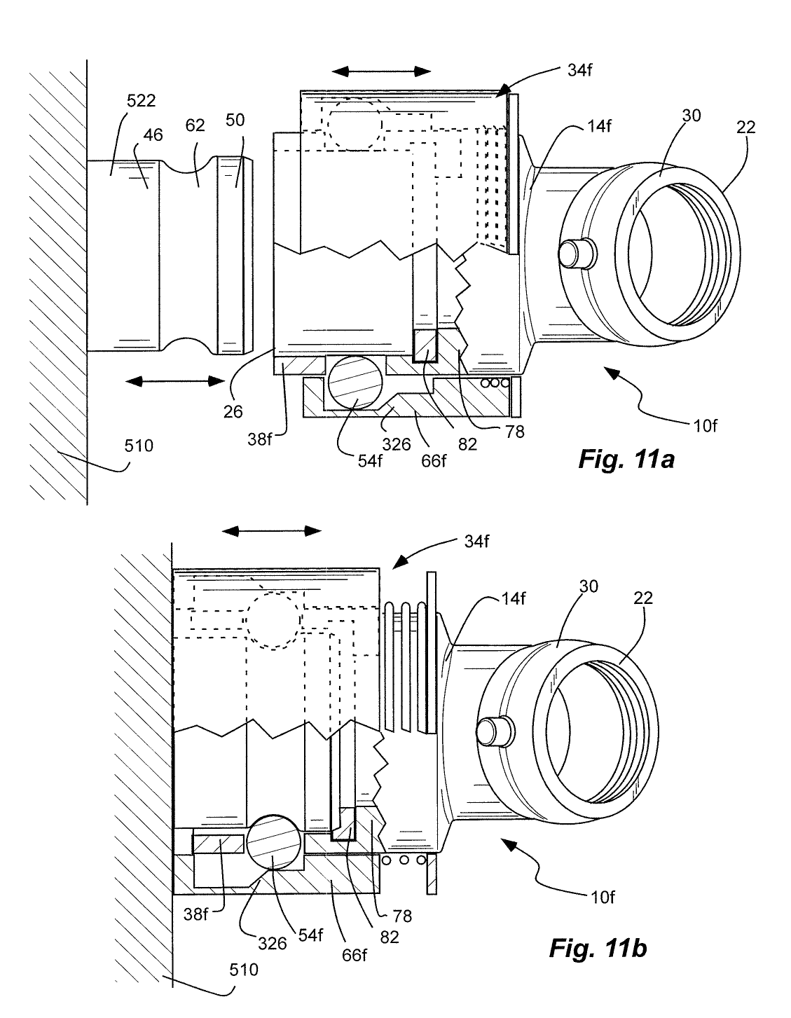

Referring to FIGS. 11a and 11b, another FDC 10f is shown that is similar in most respects to those described above, and which description is hereby incorporated herein by reference. The FDC 10f has a quick-connect 34f that can be or can comprise a slide-bearing lock. The slide-bearing lock can be similar to the twist-bearing lock, described above, but with a sliding sleeve, rather than a twisting sleeve. The slide-bearing lock can comprise an annular bearing carriage 38f extending from the fitting. Bearings 54f can be carried by the annular bearing carriage 38f, such as in holes disposed around the carriage. Thus, the bearing 54f can be disposed around or can circumscribe the carriage 38f, and thus the building inlet 522. The bearings 54f can be capable of displacing into and out of a groove 62 in the building inlet 522. A sleeve 66f can be disposed around the bearing carriage 38f, and slidable along the bearing carriage. Tabs 326 can be disposed on an inside of the sleeve 66f, and can correspond in number and location to the bearings 54f. The tabs 326 can be inclined, or can have an inclined ramp adjacent the tabs. The tabs 326 can be capable of displacing the bearings 54f into and out of the groove 62 in the building inlet 522 as the sleeve 66f slides on the bearing carriage 38f. Thus, sliding the sleeve 66f can position the tabs 326 behind the bearings 54f, displacing the bearings into the groove 62 of the building inlet 522, defining a locked orientation of the sleeve 38f and the quick-connect 34f, as shown in FIG. 11b. Sliding the sleeve 66f back can remove the tabs 326 from behind the bearings 54f, allowing the bearings to displace out of the groove 62 of the building inlet 522. In one aspect, the bearings 54f can be biased inwardly. In another aspect, the sleeve 66f can be biased in the locked orientation, such as with a spring.

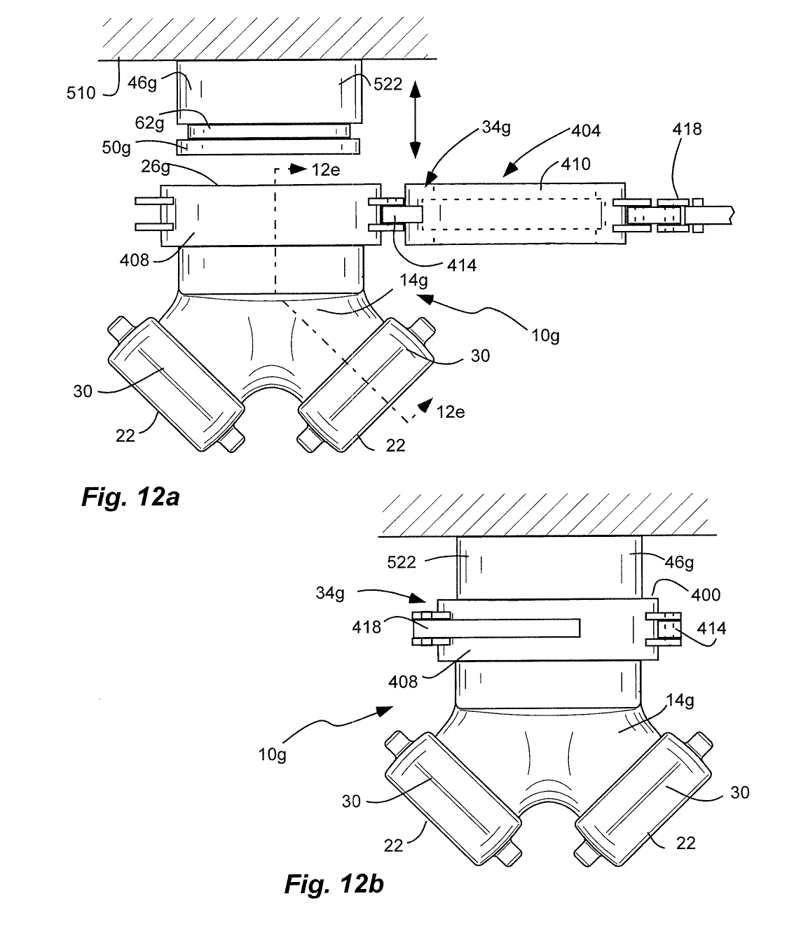

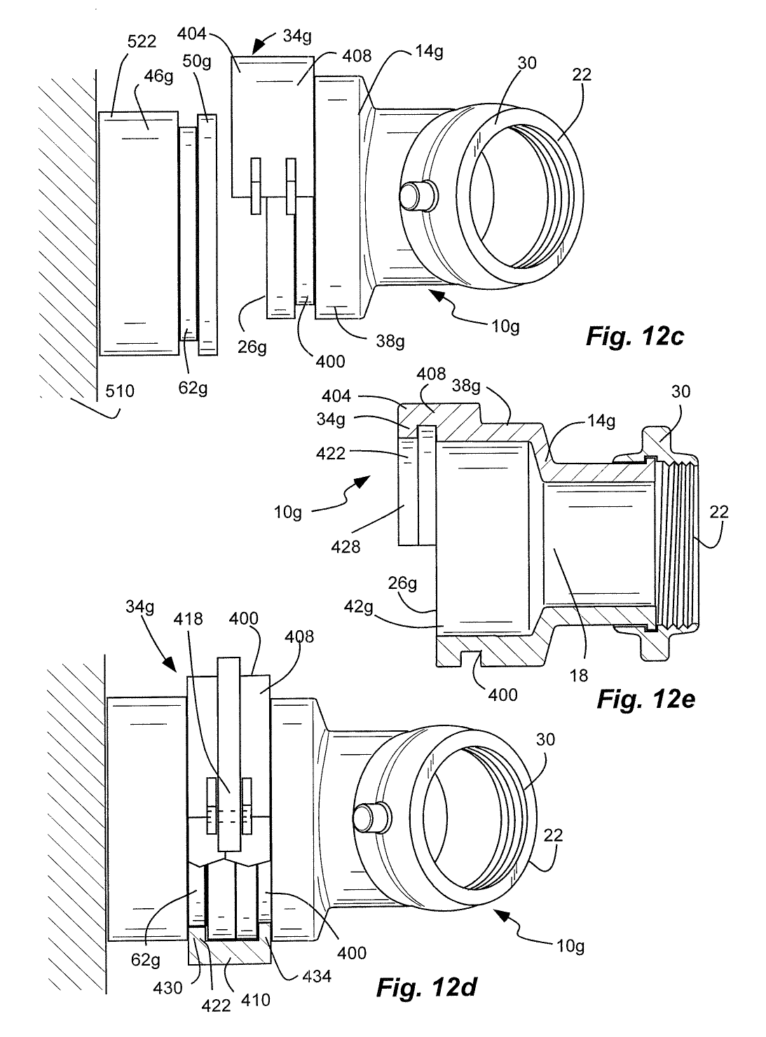

Referring to FIGS. 12a-e, another FDC 10g is shown that is similar in most respects to those described above, and which description is hereby incorporated herein by reference. The FDC 10g has a quick-connect 34g that can be or can comprise a quick-release joint coupling. The quick-release joint coupling can comprise a pair of spaced-apart annular channels, namely: an annular channel 62g (FIGS. 12a and 12c) formed around an exterior of the stem 46g of the plug 50g of the building inlet 522, and a proximal annular channel 400 (FIGS. 12c and 12e) at least partially circumscribing the outlet 26g and/or collar 38g of the housing 14g. In one aspect, the annular channels 62g and 400 can have a rectangular or square profile or cross-section with straight sides perpendicular to a straight bottom in order to provide a positive lock or connection, as described below.

In addition, the quick-release joining can comprise an annular clamp 404 segmented into a pair of clamp portions or arcs 408 and 410 pivotally coupled together. A hinge 414 (FIGS. 12a and 12b) pivotally couples one side of the pair of clamp portions 408 and 410 together. In addition, a fastener 418 coupled to and between the other side of the pair of clamp portions 408 and 410, and releasably fastening the other side of the pair of clamp portions together. One portion of the fastener can be carried by one of the clamp portions, while another portion of the fastener can be carried by the other of the pair of clamp portions. The fastener can comprise a linkage coupled to one of the pair of clamp portions, and a hook disposed on the other of the pair of clamp portions. The linkage can be manipulated or pivoted into and out of engagement with the hook to lock and unlock, respectively, the clamp 404.

The annular clamp 404 also comprises a distal ring 422, segmented along with the annular clamp into a pair of ring portions 428 and 430, and receivable in the annular channel 62g of the stem 46g, as shown in FIGS. 12d and 12e. In addition, the annular clamp 404 also comprises at least a proximal arc 434 carried by one of the pair of clamp portions 410 and receivable in the annular channel 400 of the outlet 26g and/or collar 38g of the housing 14g of the FDC 10g, as shown in FIG. 12d.

Thus, the quick-release joint coupling can also comprise a pair of spaced-apart rings, or spaced-apart ring 422 and arc 434, engaging the pair of spaced-apart annular channels 62g and 400. Thus, the outlet 26g and/or socket 42g of the housing 14g of the FDC 10g is removably coupled to the inlet 522 of the building 510 with the pair of clamp portions 408 and 410 capable of clamping on the stem 46g of the plug 50g of the building inlet 522, with the distal ring 422 (and 428 and 430) clamping in the annular channel 62g of the stem 46g, and the at least proximal arc 434 clamping into the annular channel 400 of the outlet 26g and/or collar 38g of the housing 14g of the FDC 10g.

In one aspect, the quick-connect 34g is carried by the FDC 10g or housing 14g thereof. At least a portion of the quick-connect 34g, such as one of the clamp portions 408 and the proximal annular channel 400, are integrally formed with the housing 14g as a single piece. The other clamp portion 410 is pivotally coupled to the housing 14g and/or the clamp portion 408. Thus, the annular channel 400 at least partially circumscribing the outlet 26g of the housing 14g is a semi-channel, as shown. The outlet 26g of the housing 14g forms one of the pair of clamp portions 408, defining a fixed clamp, with a fixed portion 428 of the distal ring 422. The other clamp 410 of the pair of clamp portions 404 pivots with respect to the housing 14g, defining a free clamp, with the at least a proximal arc 434 and a free portion 430 of the distal ring 422 carried thereby. Thus, the outlet 26g of the housing 14g is removably coupled to the inlet 522 of the building 510 with the fixed clamp 408 being capable of being placed on the stem 46g of the building inlet 522 with the fixed portion 428 of the distal ring 422 in the annular channel 62g of the stem 46g8, and pivoting the free clamp 410 to the fixed clamp 408 with the free portion 430 of the distal ring 422 in the annular channel 62g of the stem 46g, and the at least a proximal arc 434 in the semi-channel 400 of the outlet 26g of the housing 14g.

Removably coupling the outlet 26g of the FDC 10g to the building inlet 522 can comprise placing the fixed clamp 408 on the stem 46 of the building inlet 522 with the fixed portion 428 of the distal ring 422 in the annular channel 62g of the stem 46, and pivoting the free clamp 410 to the fixed clamp 408 with the free portion 430 of the distal ring 422 in the annular channel 62g of the stem 46g, and the at least a proximal arc 434 in the semi-channel 400 of the outlet 26g of the housing 14g. Removing the FDC 10g from the building inlet 522 can further comprise pivoting the free clamp 410 from the fixed clamp 408 with the free portion 430 of the distal ring 422 out of the annular channel 62g of the stem 46g, and the at least a proximal arc 434 out of the semi-channel 400 of the outlet 26g of the housing 14g. In addition, the fixed claim 408 can be removed from the stem 46g of the building inlet 522 with the fixed portion 428 of the distal ring 422 out of the annular channel 62g of the stem 46g.

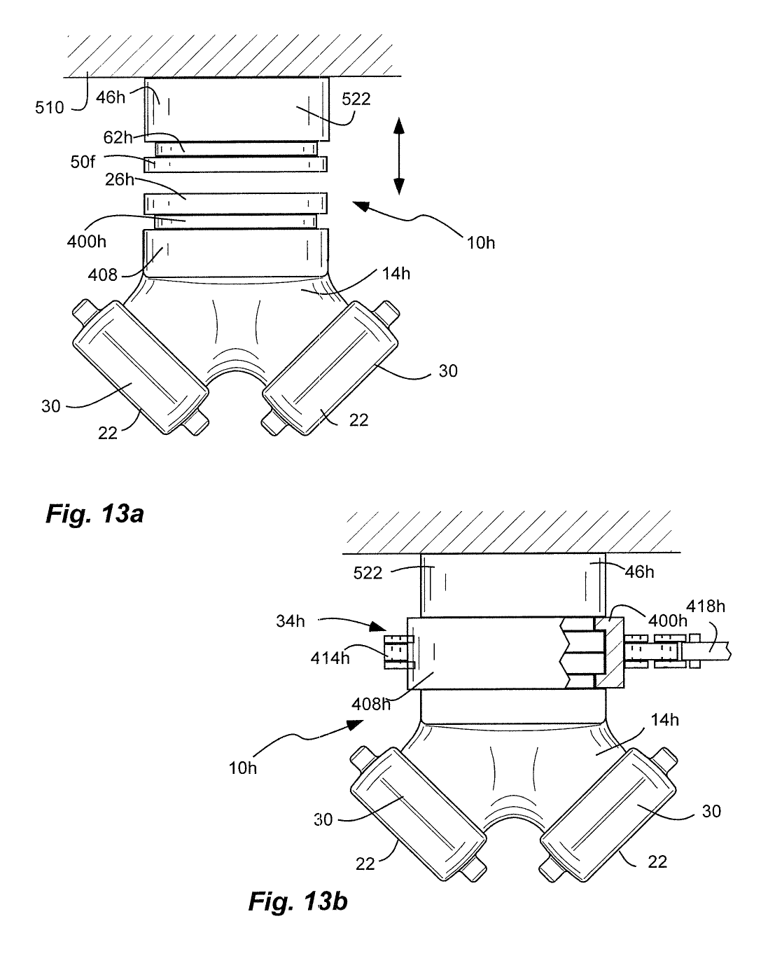

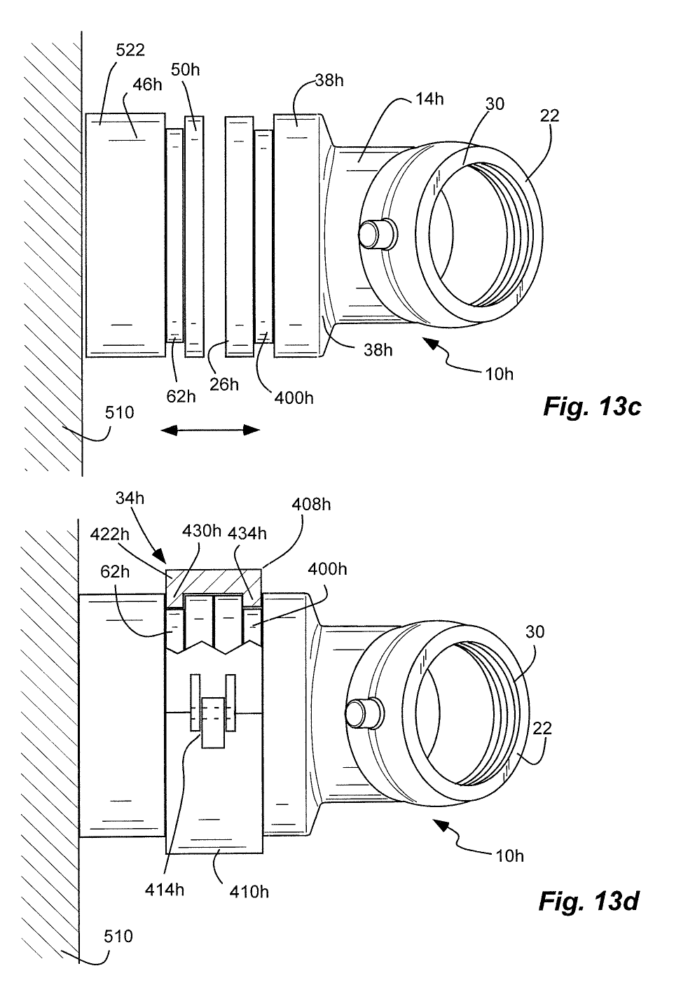

Referring to FIGS. 13a-d, another FDC 10h is shown that is similar in most respects to those described above, and which description is hereby incorporated herein by reference. The FDC 10h has a quick-connect 34h that can be or can comprise a quick-release joint coupling that can be separable from both the FDC 10h and the inlet 522 of the building 510. The quick-release joint coupling can comprise a pair of spaced-apart annular channels, namely: a distal annular channel 62h formed around an exterior of the stem 46h of the plug 50h of the building inlet 522 of the building 510, and a proximal annular channel 400h circumscribing the outlet 26h and/or collar 38h of the housing 14h. In addition, the quick-release joint coupling can comprise an annular clamp 404h engaging the pair of spaced-apart annular channels 62h and 400h, with a pair of spaced-apart rings, namely distal ring 422h and proximal ring 434h, engaging the pair of spaced-apart channels. The annular clamp 404h can comprise the annular clamp being segmented into a pair of clamp portions or arcs 408h and 410h pivotally coupled together. A hinge 414h can pivotally couple one side of the pair of clamp portions or arcs 408h and 410h. A fastener 418h can be coupled to and between another side of the pair of clamp portions or arcs 408h and 410h to releasably fasten the another side of the pair of clamp portions or arcs together. A pair of rings 422h and 434h can be disposed on an interior of the clamp 404h, or pair of clamp portions or arcs 408h and 410h. The pair of rings 422h and 434h can be spaced-apart from one another. In addition, the pair of rings 422h and 434h can be segmented along with the annular clamp 404h. The pair of rings can comprise a proximal ring 434h receivable in the annular channel 400h of the housing 14h or outlet 26h thereof of the FDC 10h, and a distal ring 422h capable of being received in an annular channel 62h formed around an exterior of the building inlet 522. The fastener 418h can comprise a linkage coupled to one of the pair of clamp portions or arcs, and a hook disposed on the other of the pair of clamp portions or arcs. The linkage can be manipulated or pivoted into and out of engagement with the hook to lock and unlock, respectively, the clamp.

Removably coupling the outlet 26h of the FDC 10h to the building inlet 522 can comprise clamping the pair of clamp portions 408h and 410h on the stem 46h of the building inlet 522 with the distal ring 422h clamping in the annular channel 62h of the stem 46h, and the proximal arc 434h clamping into the annular channel 40h of the outlet 26h of the housing 14h. Removing the FDC 10h from the building inlet 522 can further comprise unclamping the pair of clamp portions 408h and 410h from the stem 46h of the building inlet 522 with distal ring 422h unclamping from the annular channel 62h of the stem 46h.

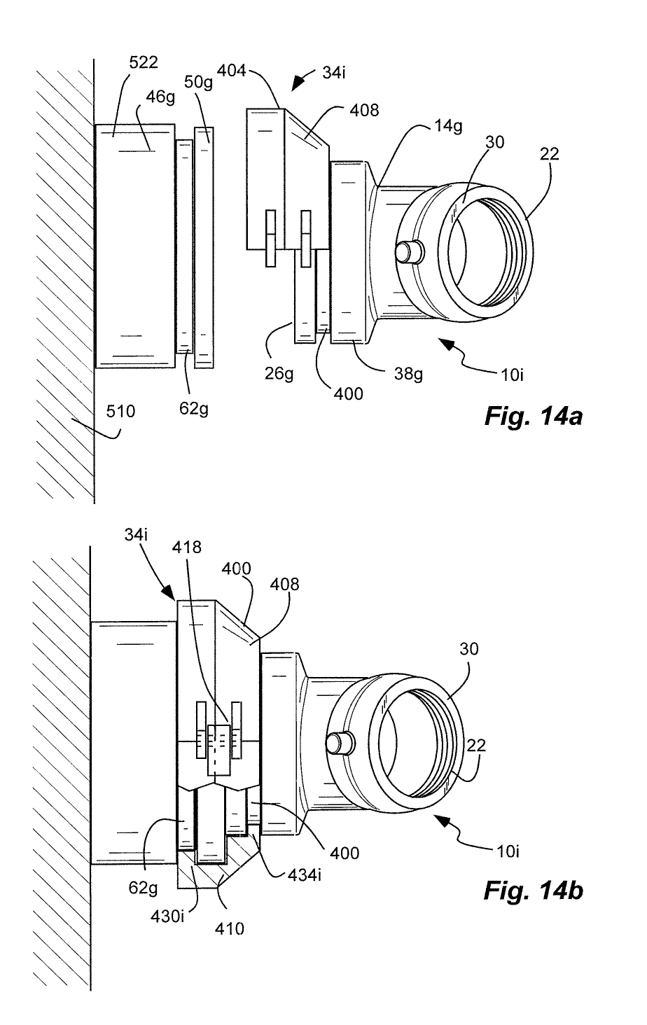

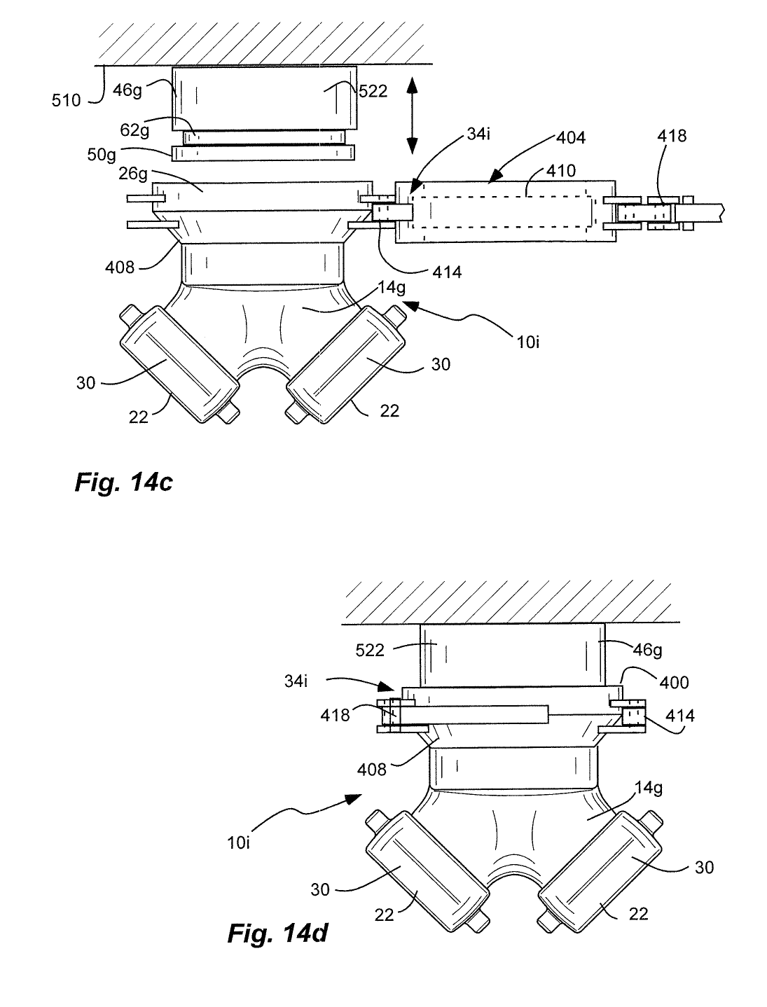

Referring to FIGS. 14a-d, another FDC 10i is shown that is similar in most respects to those described above, and which description is hereby incorporated herein by reference. The FDC 10i has a quick-connect 34i that can be or can comprise a quick-release joint coupling that can be or can comprise a reduction connection. The reduction connection can be as described above with respect to the quick-release joint coupling, but with a larger opening coupled to the building inlet. Thus, the distal ring 430i has a greater inner diameter than the proximal ring 434i.

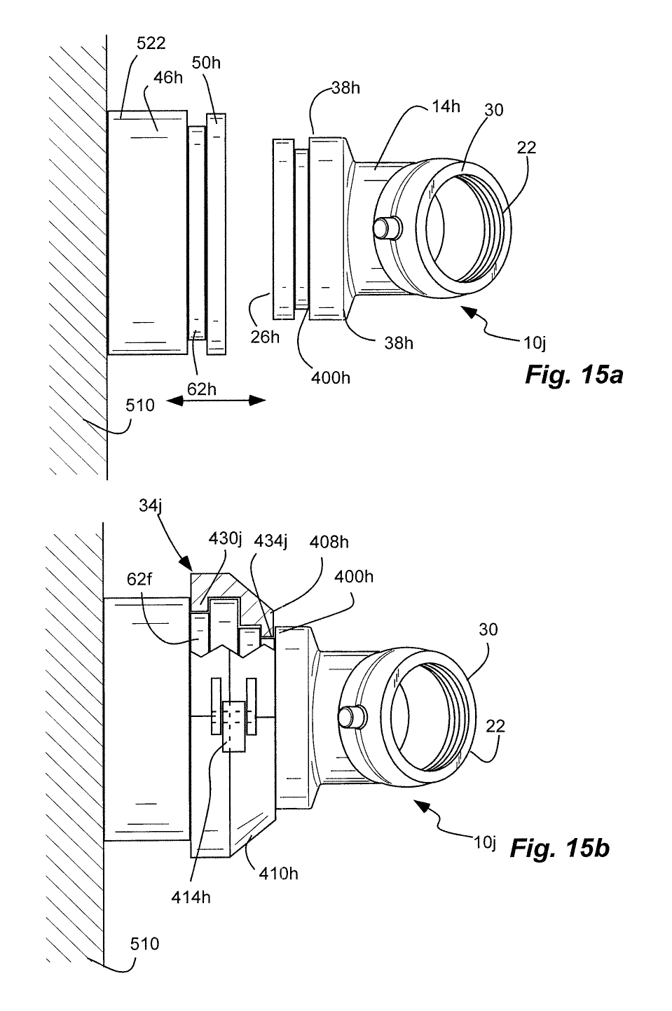

Referring to FIGS. 15a and 15b, another FDC 10j is shown that is similar in most respects to those described above, and which description is hereby incorporated herein by reference. The FDC 10j has a quick-connect 34j that can be or can comprise a quick-release joint coupling that can be or can comprise a reduction connection. The reduction connection can be as described above with respect to the quick-release joint coupling, but with a larger opening on one side or end, and a smaller opening on the opposite side or end. For example, the larger opening can coupled to the building inlet, while the smaller opening can couple to the outlet of the fitting or FDC. Thus, the distal ring 430j has a greater inner diameter than the proximal ring 434j.

In another aspect, the FDC, fitting and/or quick-connect can comprise a gasket carried by the quick-connect. The fitting and/or the quick-connect can be configured to retain the gasket. A tab can be removably received in a slot formed between the gasket and the annular clamp to retain the gasket to the annular clamp.

As described above, the quick-connect, or quick-release joint coupling, can also be a reduction connection. The distal semi-ring can have a greater inner diameter than the proximal semi-ring.

As described above, the quick-connect or quick-release joint coupling can further comprise a gasket carried by the quick-connect. A tab can be removably received in a slot formed between the gasket and the annular clamp to retain the gasket to the annular clamp.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A method for providing supplemental water to a building with a building inlet to a fire sprinkler and/or standpipe system, comprising:
a) carrying a fire department connection (FDC) on a pumper truck having a water tank, a pump, and a hose, the FDC comprising a housing with at least one inlet and an outlet;
b) transporting the FDC on the pumper truck to the building with the building inlet to the fire sprinkler and/or standpipe system;
c) removing the FDC from the pumper truck;
d) removably coupling the outlet of the FDC to the building inlet with a quick-connect;
e) coupling the hose between the pumper truck and the at least one inlet of the FDC;
f) pumping water from the truck, through the hose and the FDC, to the fire sprinkler and/or standpipe system of the building;
g) removing the FDC from the building inlet; and
h) replacing the FDC on the pumper truck.

2. The method in accordance with claim 1, wherein at least a portion of the quick-connect is permanently affixed to, and carried by, the housing of the FDC; and wherein carrying, transporting, removing and replacing the FDC further comprises carrying, transporting, removing and replacing the at least a portion of the quick connect along with the FDC.

3. The method in accordance with claim 1, wherein removably coupling the outlet of the FDC to the building inlet and removing the FDC from the building inlet comprises manually operating the quick-connect without tools.

4. The method in accordance with claim 1, wherein the FDC further comprises a collar extending from the housing at the outlet, and defining a socket of the quick-connect;
wherein the building inlet further comprises a stem defining a plug of the quick-connect; and
wherein removably coupling the outlet of the FDC to the inlet of the building comprises:
sliding the collar of the FDC over the stem of the building inlet.

5. The method in accordance with claim 4, wherein the building inlet further comprises a groove formed in the stem; wherein the FDC further comprises:
a cam pivotally affixed to the collar of the housing, and capable of pivoting into and out of the groove in the stem of the building inlet; and
an arm fixed to the cam and capable of pivoting the cam;
wherein removably coupling the outlet of the FDC to the building inlet further comprises:
pivoting the cam into the groove of the stem of the building inlet; and
wherein removing the FDC from the building inlet further comprises:
pivoting the cam out of the groove of the stem of the building inlet.

6. The method in accordance with claim 1, wherein the FDC further comprises an outlet seal to seal the outlet of the housing of the FDC with the building inlet; and wherein the outlet seal comprises:
a) an interior annular flange disposed in the outlet of the housing; and
b) a gasket disposed in the outlet of the housing adjacent the interior annular flange; and
wherein removably coupling the outlet of the FDC to the building inlet further comprises:
abutting the building inlet of the building fire sprinkler and/or standpipe system to the gasket in the outlet of the housing of the FDC.

7. The method in accordance with claim 1, further comprising:
a) carrying an adaptor fitting with an inlet and an outlet having different sizes;
b) transporting the adaptor on the pumper truck to the building;
c) removing the adaptor from the pumper truck;
d) removably coupling the outlet of the adaptor to the building inlet with an adaptor quick-connect;
e) removably coupling the outlet of the FDC to the inlet of the the adaptor with the quick-connect, thus removably coupling the outlet of the FDC to the building inlet via the adaptor;
f) removing the adaptor from the building inlet; and
g) replacing the adaptor on the pumper truck.

8. The method in accordance with claim 1, wherein the building inlet further comprises:
a stem defining a plug of the quick-connect; and
an annular groove or channel circumscribing the stem;
wherein the FDC further comprises:
a collar extending from the housing of the outlet, and defining a socket of the quick-connect; and
one or more cams, balls or pins, carried by the collar;
wherein removably coupling the outlet of the FDC to the inlet of the building comprises:
displacing the one or more cams, balls or pins radially inwardly and into the groove or channel of the stem; and
wherein removing the FDC from the building inlet further comprises:
displacing the one or more cams, balls or pins radially outwardly and out of the groove or channel of the stem.

9. The method in accordance with claim 1, wherein the building inlet further comprises:
a stem defining a plug of the quick-connect; and
an annular channel circumscribing the stem;
wherein the FDC further comprises:
an annular channel at least partially circumscribing the outlet of the housing;
an annular clamp segmented into a pair of clamp portions pivotally coupled together, and comprising:
a hinge pivotally coupling one side of the pair of clamp portions;
a fastener coupled to and between the other side of the pair of clamp portions and releasably fastening the other side of the pair of clamp portions together;
a distal ring segmented along with the annular clamp and receivable in the annular channel of the stem; and
at least a proximal arc carried by one of the pair of clamp portion and receivable in the annular channel of the outlet of the housing; and
wherein removably coupling the outlet of the FDC to the inlet of the building comprises:
clamping the pair of clamp portions on the stem of the building inlet with the distal ring clamping in the annular channel of the stem, and the at least the proximal arc clamping into the annular channel of the outlet of the housing; and
wherein removing the FDC from the building inlet further comprises:
unclamping the pair of clamp portions from the stem of the building inlet with distal ring unclamping from the annular channel of the stem.

10. The method in accordance with claim 9, wherein the FDC further comprises a semi-channel formed by the annular channel at least partially circumscribing the outlet of the housing, and the outlet of the housing forms one of the pair of clamp portions, defining a fixed clamp, with a fixed portion of the distal ring, while the other of the pair of clamp portions pivots with respect to the housing, defining a free clamp, with the at least a proximal arc and a free portion of the distal ring carried thereby; wherein removably coupling the outlet of the FDC to the inlet of the building comprises:
placing the fixed clamp on the stem of the building inlet with the fixed portion of the distal ring in the annular channel of the stem; and
pivoting the free clamp to the fixed clamp with the free portion of the distal ring in the annular channel of the stem, and the at least a proximal arc in the semi-channel of the outlet of the housing; and
wherein removing the FDC from the building inlet further comprises:
pivoting the free clamp from the fixed clamp with the free portion of the distal ring out of the annular channel of the stem, and the at least a proximal arc out of the semi-channel of the outlet of the housing; and
removing the fixed clamp from the stem of the building inlet with the fixed portion of the distal ring out of the annular channel of the stem.

11. A fire department connection (FDC) device, comprising:
a) a housing with a hollow therethrough, at least one inlet at one end of the hollow, and an outlet at another end of the hollow;
b) at least one female swivel fitting at the at least one inlet configured to be removably coupled to a fire hose; and
c) a quick-connect disposed on the outlet of the housing and capable of releasably coupling the outlet of the housing to a building inlet of a building fire sprinkler and/or standpipe system.

12. The FDC device in accordance with claim 11, wherein at least a portion of the quick-connect is permanently affixed to the housing.

13. The FDC device in accordance with claim 11, wherein the quick-connect is manually operated and capable of coupling to and releasing from the building inlet without tools and without pipe threads.

14. The FDC device in accordance with claim 11, further comprising:
a collar extending from the housing at the outlet, and defining a socket of the quick-connect, capable of receiving a stem of the building inlet defining a plug of the quick-connect.

15. The FDC device in accordance with claim 14, further comprising:
a cam pivotally affixed to the collar of the housing, and capable of pivoting into and out of a groove in the stem of the building inlet; and
an arm fixed to the cam and capable of pivoting the cam.

16. The FDC device in accordance with claim 11, further comprising an outlet seal configured to seal the outlet of the housing with the building inlet, the outlet seal comprising:
a) an interior annular flange disposed in the outlet of the housing; and
b) a gasket disposed in the outlet of the housing adjacent the interior annular flange, and configured to abut to the building inlet of the building fire sprinkler and/or standpipe system.

17. The FDC device in accordance with claim 1, further comprising:
a) an adaptor fitting with an inlet and an outlet having different sizes;
b) an adaptor quick-connect carried by the adaptor fitting and configured to removably couple the outlet of the adaptor to the building inlet; and
e) the quick connect of the outlet of the housing releasably coupling the outlet of the housing to the inlet of the the adaptor, thus removably coupling the outlet of the housing to the building inlet via the adaptor.

18. The FDC device in accordance with claim 11, wherein the FDC further comprises:
a) a collar extending from the housing of the outlet, and defining a socket of the quick-connect; and
b) one or more cams, balls or pins, carried by the collar and displaceable radially inwardly configured to be received within an annular groove or channel of a stem of the building inlet, and displaceable radially outwardly configured to be disposed out of the annular groove or channel of the stem of the building inlet.

19. The FDC device in accordance with claim 11, further comprising:
a) an annular channel at least partially circumscribing the outlet of the housing;
b) an annular clamp segmented into a pair of clamp portions pivotally coupled together, and comprising:
i) a hinge pivotally coupling one side of the pair of clamp portions;
ii) a fastener coupled to and between the other side of the pair of clamp portions and releasably fastening the other side of the pair of clamp portions together,
iii) a distal ring segmented along with the annular clamp and receivable in the annular channel of the stem; and
iv) at least a proximal arc carried by one of the pair of clamp portion and receivable in the annular channel of the outlet of the housing; and
c) wherein the outlet of the housing is configured to be removably coupled to the inlet of the building with the pair of clamp portions capable of clamping on the stem of the building inlet with the distal ring clamping in the annular channel of the stem, and the at least the proximal arc clamping into the annular channel of the outlet of the housing.

20. The FDC device in accordance with claim 19, further comprising:
a) a semi-channel formed by the annular channel at least partially circumscribing the outlet of the housing;
b) the outlet of the housing forming one of the pair of clamp portions, defining a fixed clamp, with a fixed portion of the distal ring;
c) the other of the pair of clamp portions pivots with respect to the housing, defining a free clamp, with the at least a proximal arc and a free portion of the distal ring carried thereby; and
d) wherein the outlet of the housing is configured to be removably coupled to the inlet of the building with the fixed clamp being capable of being placed on the stem of the building inlet with the fixed portion of the distal ring in the annular channel of the stem, and pivoting the free clamp to the fixed clamp with the free portion of the distal ring in the annular channel of the stem, and the at least a proximal arc in the semi-channel of the outlet of the housing.

21. A fire department connection system configured to provide supplemental water to a building with a building inlet to a fire sprinkler and/or standpipe system, the system comprising:
a) a fire department connection (FDC) device configured to releasably connect to the building inlet, the FDC device comprising:
i) a housing with a hollow therethrough, at least one inlet at one end of the hollow, and an outlet at another end of the hollow;
ii) at least one female swivel fitting at the at least one inlet configured to be removably coupled to a fire hose; and
iii) a quick-connect disposed on the outlet of the housing; and
b) an adaptor configured to releasably connect to the building inlet to coupled the FDC device to the building inlet, the adaptor comprising:
i) an adaptor fitting with an inlet and an outlet, where the outlet of the adaptor is a different size than the outlet of the FDC device, and where the inlet of the adaptor fitting is the same size as the outlet of the FDC device;
ii) an adaptor quick-connect carried by the adaptor fitting and configured to removably couple the outlet of the adaptor to the building inlet; and
iii) the quick connect of the outlet of the housing releasably coupling the outlet of the housing to the inlet of the the adaptor, thus removably coupling the outlet of the housing to the building inlet via the adaptor.
